(19) United States
(12) Patent Application Publication
(10) Pub. No.: US 2013/0019293 A1
(43) Pub. Date: Jan. 17, 2013

(54) Enabling Access to Electronic Content Based on Possession of Physical Content

(71) Applicant: Diego Puppin, Arlington, MA (US)

(72) Inventor: Diego Puppin, Arlington, MA (US)

(73) Assignee: GOOGLE INC., Mountain View, CA (US)

(21) Appl. No.: 13/183,400

(22) Filed: Jul. 14, 2011

(51) Int. Cl. H04L 9/32; G06F 15/16; G06F 21/00

(52) U.S. Cl. 726/7

(57) ABSTRACT

A user may desire to access an electronic version of content the user possesses in physical form. To enable access to electronic content, a request to access identified electronic content is received from a client. A challenge requesting information about physical content corresponding to the identified electronic content is sent to the client. A response to the challenge is received from the user of the client and authenticated. The client is provided with access to the electronic content responsive to authenticating the response.

### BACKGROUND

1. Field of Art

The present invention generally relates to the field of electronic content distribution and more specifically to distribution of electronic books and other text-based content.

2. Background Information

Many people are transitioning from reading physical books to reading electronic books (“eBooks”). This transition leads to a dichotomy in the readers' libraries: physical books purchased before the transition to electronic reading, and eBooks purchased after the transition. Oftentimes, the readers desire to access electronic versions of the books they own in physical form. There are a number of advantages of eBooks over physical books, such as more portability, the ability to access the eBook from multiple electronic devices, and text search capability.

However, readers are reluctant to purchase electronic copies of books they already own. Recognizing this reluctance, some eBook vendors desire to offer free or discounted eBooks to readers that have already purchased corresponding physical books. To provide such discounts to readers that are remote from the vendors requires the readers to prove that they possess the physical books. It is difficult for the readers to provide this proof.

### SUMMARY

The above and other issues are addressed by a method, non-transitory computer-readable storage medium storing executable computer program instructions, and computer system for enabling access to electronic content. An embodiment of the method comprises receiving a request to access identified electronic content from a client and sending a challenge for the electronic content to the client. The challenge requests information about physical content corresponding to the identified electronic content. The method also comprises authenticating a response to the challenge received from the client and providing the client with access to the electronic content responsive to authenticating the response.

An embodiment of the non-transitory computer-readable storage medium stores executable computer program instructions for enabling access to electronic content, the instructions performing steps comprising receiving a request to access identified electronic content from a client and sending a challenge for the electronic content to the client. The challenge requests information about physical content corresponding to the identified electronic content. The steps also comprise authenticating a response to the challenge received from the client and providing the client with access to the electronic content responsive to authenticating the response.

An embodiment of the computer system comprises a non-transitory computer-readable storage medium storing executable computer program instructions for performing steps comprising receiving a request to access identified electronic content from a client and sending a challenge for the electronic content to the client. The challenge requests information about physical content corresponding to the identified electronic content. The steps also comprise authenticating a response to the challenge received from the client and providing the client with access to the electronic content responsive to authenticating the response. The computer system further comprises a processor for executing the computer program instructions.

### BRIEF DESCRIPTION OF DRAWINGS

FIG. 1 is a high-level block diagram illustrating an environment for providing access to electronic content according to one embodiment.

FIG. 2 is a high-level block diagram illustrating an example of a computer for use as a client and/or server according to one embodiment.

FIG. 3 is a high-level block diagram illustrating a detailed view of the challenge module of the client according to one embodiment.

FIG. 4 is a high-level block diagram illustrating a detailed view of the authentication module of the server according to one embodiment.

FIG. 5 is a flowchart illustrating a method for providing eBook access to a client.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures.

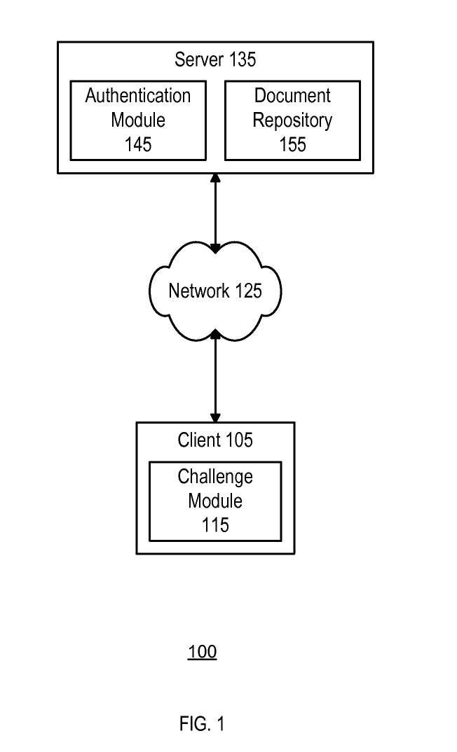

FIG. 1 is a high-level block diagram illustrating an environment 100 for providing access to electronic content according to one embodiment. As shown, the environment 100 includes a network 125 connecting a client 105 to a server 135. While only one client 105 and one server 135 are shown in FIG. 1 for clarity, embodiments can have many clients 105 and multiple servers 135. In addition, the server 135 may be implemented as a cloud-based service distributed across multiple physical servers.

The server 135 provides clients 105 with access to electronic content via the network 125. In one embodiment, the server 135 includes a document repository 155 that stores electronic (also called “digital”) copies of books, and related metadata about the books, that can be provided to the clients 105. In other embodiments, the document repository 155 is remote from the server 135. For example, the document repository 155 may be implemented as a separate cloud-based service or as a storage-area network.

As used herein, the term “book” also includes other types of primarily text-based content, such as magazines, journals, newspapers, and/or other publications. Moreover, for clarity this description uses the phrase “physical book” to mean the printed version of a book, the term “eBook” to mean a digital version of the book, and the term “book” to refer to the book in the abstract without reference to the particular form in which the book is embodied.

An authentication module 145 authenticates that a user of a client 105 requesting access to an eBook in the document repository 155 has possession of the corresponding physical book. In one embodiment, the authentication module 145 performs the authentication by issuing a challenge requesting information from the user that only a person with possession of the physical book can answer correctly. If the authentication module 145 receives a correct response to the challenge, the module determines that the user has possession of the physical book. The function of the authentication module 145 is useful, for example, in embodiments where the server 135 provides access to an eBook in the document repository 155 for free or at a discount to users that already own the physical version of the book.

The client 105 is a computer or other electronic device used by one or more users to execute applications for performing various activities. For example the client 105 can be a desktop, notebook, or tablet computer, a mobile telephone, dedicated eBook reader, or television set-top box. The applications executed by the client 105 may include eBook readers, web browsers, word processors, media players, spreadsheets, image processors, security software, etc. In one embodiment, the client 105 includes a digital camera or other optical sensor. The client 105 may also include other sensors, such as a radio-frequency identification (RFID) or near field communication (NFC) sensor and a global positioning system sensor.

Assume that a user of the client 105 owns a physical copy of a book, and desires to access (e.g., download) the corresponding eBook from the server 135 via the network 125. The user uses the client 105 to interact with the server 135 to request access to the eBook. The client 105 receives a challenge for the book issued by the server 135. A challenge module 115 at the client 105 presents the challenge to the user. The user responds to the challenge by providing the requested information about the physical book. For example, the challenge module 115 can display a message on a display device of the client 105 requesting that the user provide an image of a particular page of the book. The user uses the camera on the client 105 to take a picture of the page, which is received by the challenge module 115. The challenge module 115 provides the image (and/or data derived from the image) to the server 135 as the response to the challenge. If the response to the challenge is correct, the client 105 receives access to the requested eBook from the server 135.

The network 125 represents the communication pathway between clients 105 and the server 135. In one embodiment, the network 125 uses standard communications technologies and/or protocols and can include the Internet. Thus, the network 125 can include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the network 125 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 125 can be represented using technologies and/or formats including the hypertext markup language (HTML), the extensible markup language (XML), JavaScript, VBScript, FLASH, the portable document format (PDF), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities on the network 125 can use custom and/or dedicated data communications technologies instead of, or in addition to, the ones described above.

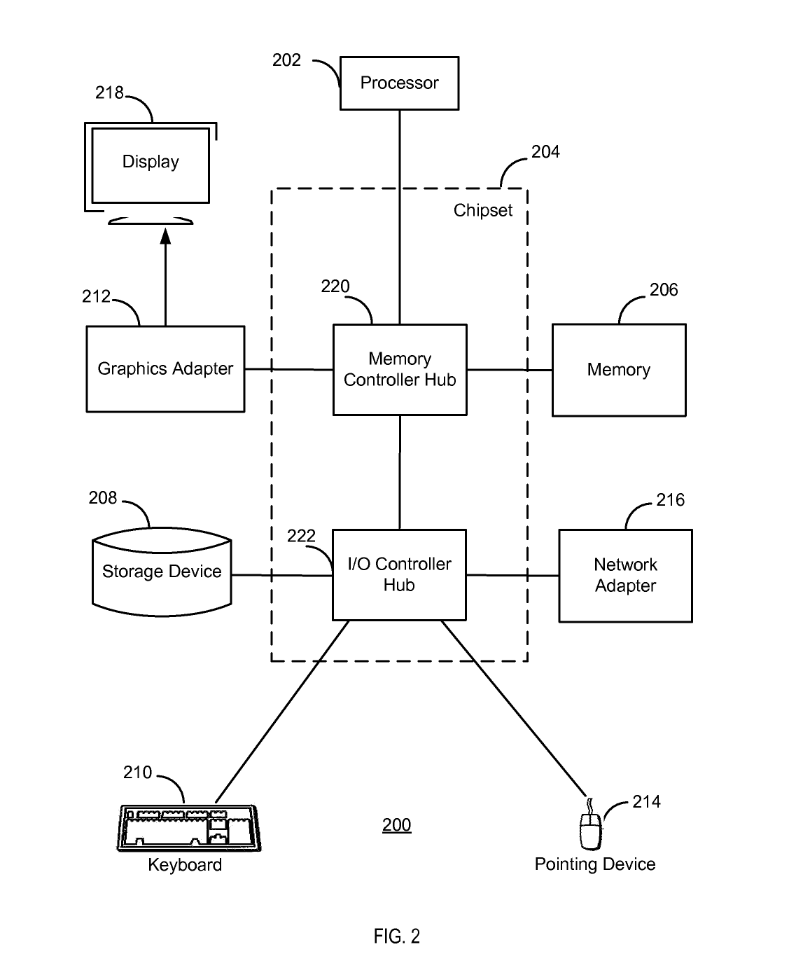

FIG. 2 is a high-level block diagram illustrating an example of a computer 200 for use as a client 105 and/or server 135 according to one embodiment. Illustrated are at least one processor 202 (CPU) coupled to a chipset 204. The chipset 204 includes a memory controller hub 220 and an input/output (I/O) controller hub 222. A memory 206 and a graphics adapter 212 are coupled to the memory controller hub 220, and a display device 218 is coupled to the graphics adapter 212. A storage device 208, keyboard 210, pointing device 214, and network adapter 216 are coupled to the I/O controller hub 222. Other embodiments of the computer 200 have different architectures. For example, the memory 206 is directly coupled to the processor 202 in some embodiments.

The storage device 208 is a non-transitory computer-readable storage medium such as a hard drive, compact disk read-only memory (CD-ROM), DVD, or a solid-state memory device. The memory 206 holds instructions and data used by the processor 202. The pointing device 214 is used in combination with the keyboard 210 to input data into the computer system 200. The graphics adapter 212 displays images and other information on the display device 218. In some embodiments, the display device 218 includes a touch screen capability for receiving user input and selections. The network adapter 216 couples the computer system 200 to the network 125. Some embodiments of the computer 200 have different and/or other components than those shown in FIG. 2. For example, the server 135 may be formed of multiple blade servers and lack a display device, keyboard, and other components.

As used herein, the term “module” refers to computer program instructions and other logic used to provide the specified functionality. Thus, a module can be implemented in hardware, firmware, and/or software. In one embodiment, program modules formed of executable computer program instructions are stored on the storage device 208, loaded into the memory 206, and executed by the processor 202 as one or more processes.

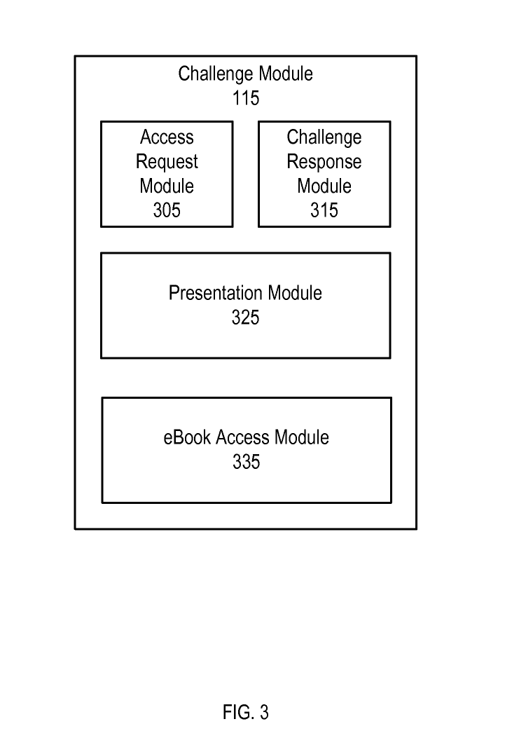

FIG. 3 is a high-level block diagram illustrating a detailed view of the challenge module 115 of a client 105 according to one embodiment. As shown in FIG. 3, the challenge module 115 itself includes multiple modules. In the embodiment shown in FIG. 3, the challenge module 115 includes an access request module 305, a challenge response module 315, a presentation module 325, and an eBook access module 335. In some embodiments, the functions are distributed among the modules in a different manner than described herein. In addition, other embodiments have additional and/or other modules.

In one embodiment, the presentation module 325 displays one or more user interfaces (UIs) on the display device 218 of the client 105 to guide the user through the access request process. The UIs can include one or more textual statements and/or images that describe the action the user should perform to access the eBook. Likewise, the UIs can include input fields or other UI elements by which the user can provide information to the challenge module 115.

The access request module 305 interacts with the user of the client 105 to identify the book to which the user is requesting access. The access request module 305 interacts with the presentation module 325 to provide a UI with which the user interacts to identify the book. For example, the UI may include fields allowing the user to provide a code or other information displayed on the physical book that uniquely identifies the book (e.g., the edition of the book) to the server 135. In addition, the physical book may display a message such as “Use this code to obtain a free digital download” and an associated code that the user provides to the access request module 305.

The access request module 305 may also use the UI to interact with the user to obtain one or more other pieces of information about the book such as the book's title, author, publisher, edition, international standard book number (ISBN), etc. The access request module 305 may then interact with the server 135 to obtain and display a list of the one or more books matching the provided information. The user may then select the corresponding book from the list.

Similarly, the UI may let the user browse a list of books received from the server 135 or elsewhere and select the book in the list corresponding to the physical book possessed by the user. For example, the UI may show a list of top selling books, a list of books by a particular author, or a list of books within a particular category or written about a particular topic.

In one embodiment, the access request module 305 allows the user to identify the physical book by selecting the corresponding eBook. For example, the access request module 305 may obtain a list of one or more eBooks from the server and the user may then select the eBook or eBooks in the list for which the user possesses corresponding physical books. The user may also identify multiple books in batch. For example, the access request module 305 can interact with the server 135 to provide an electronic shopping cart in which the user can place multiple eBooks offered by the server. The access request module 305 can provide the user with a UI allowing the user to identify eBooks in the shopping cart for which the user already owns corresponding physical books. Thus, through these interactions with the access request module 305, the user identifies one or more specific physical books. The access request module 305 provides the identities of the book or books identified by the user to the server 135.

In addition to identifying a book, an embodiment of the access request module 305 provides the server 135 with information describing the types of challenges the client 105 can answer. The types of answerable challenges may depend on the hardware capabilities of the client 105. For example, the access request module 305 can provide the server 135 with information indicating that the client 105 supports location-based services, supports RFID/NFC services, supports imaging services (e.g., has a camera), supports textual input, etc. The access request module 305 can also provide the server 135 with information derived from these capabilities, such as the current location of the client 105.

The challenge response module 315 receives challenges from the server 135 based on identified books and transmits challenge responses to the server. As mentioned above, a challenge is designed to verify that the user has possession of the physical version of the identified book. Thus, the challenge asks for information about the physical book that only a person in possession of the physical book can provide. The specific types of information requested by challenges can vary in different embodiments, for different books, and/or for different users in possession of the same book. Likewise, the information requested by the challenge can vary based on the types of challenges that the client 105 can answer. While it may be possible for a dedicated malicious actor to fraudulently provide the correct responses to some challenges, the challenges at the least serve to prevent casual fraud on the part of users.

The challenge response module 315 sends the challenge response to the server 135. The response includes the information provided by the user of the client 105 and/or a transformation of the information. For example, if the challenge is “Provide the seventh word on page 35 of the book” the response may include the text entered by the user in response to the challenge. If the challenge is “Provide an image of page 75 of the book” the response may include the image provided by the user, text recognized in the image, and/or hash or other transformation of the image.

In some embodiments the operations of the access request module 305 and challenge response module 315 are combined. In such an embodiment, the interactions performed by the user to identify the physical book also serve as the response to the challenge. For example, the user can use the access request module 305 to submit an image of the front cover of the physical book to the server 135. The server 135 may use this image to identify the book, and also treat the image as the response to an implicit challenge asking for the image of the book cover. Similarly, if the user uses the client 105 to scan a RFID or NFC tag associated with the physical book and send information in the tag to the server 135, the user's actions identify the book and respond to an implicit challenge asking for information in the book's tag.

The eBook access module 335 enables access to the requested eBook if the authentication module 145 of the server 135 authenticates the response as correct. As mentioned above, the server 135 may provide access to the eBook for free or at a discount because the user already possesses a physical copy of the book. The eBook access module 335 may, for example, download the eBook to the client 105 and/or display portions of an online version of the book maintained by the server 135 or elsewhere on the network 125. The user may then read the eBook using the client 105 and/or on another device.

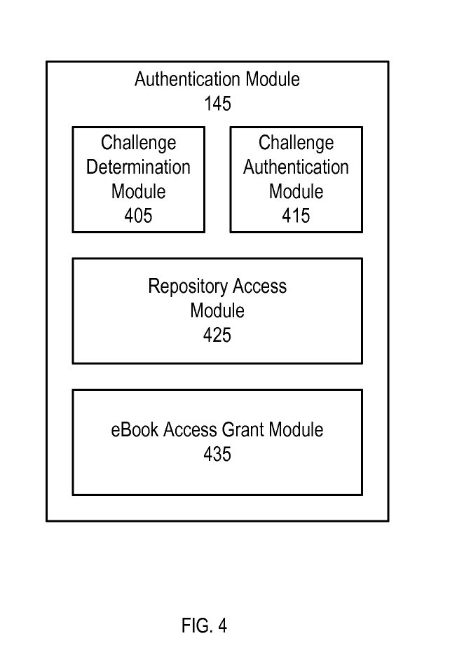

FIG. 4 is a high-level block diagram illustrating a detailed view of the authentication module 145 of the server 135 according to one embodiment. As shown in FIG. 4, the authentication module 145 includes a challenge determination module 405, a challenge authentication module 415, a document repository access module 425, and an eBook Access Grant module 435. In some embodiments, the functions are distributed among the modules in a different manner than described herein. In addition, other embodiments have additional and/or other modules.

The challenge determination module 405 provides challenges in response to access requests received from clients 105. In general, the challenge determination module 405 identifies a book for which a challenge is being requested, selects a challenge for the book, and provides the challenge to the requesting client 105. The book is identified using the interactions with the access request module 305 described above. The challenge determination module 405 receives information about the book and uses the information to identify the book for which the challenge is requested.

There are a variety of ways that the challenge determination module 405 can select the challenge for the identified book. In one embodiment, the challenge determination module 405 dynamically generates a challenge based on characteristics of the book. For example, the challenge determination module 405 can randomly select a page of the book and a location on the page, and generate a challenge based on the text at that page of the book (e.g., “Provide the third word on the second line of page 200” or “Provide an image of page 42 of the book”). The challenge determination module 405 also determines the correct response to the challenge and stores it in association with the challenge.

In another embodiment, the challenge determination module 405 selects a challenge from among a set of one or more pre-generated challenges and associated correct responses. The set of pre-generated challenges may be associated with a specific book or with multiple books. For example, the challenge can request that the client 105 provide a photograph of a cover or a pre-identified page of a book, provide a tag value from an RFID/NFC tag in the book, provide an image of a bar code on a particular page of the book, etc.

The challenge determination module 405 may select the challenge based on the hardware capabilities of the client 105. For example, the challenge determination module 405 may dynamically generate a challenge requesting that the user provide an image of a specific page of the book if the client 105 includes imaging capabilities. Similarly, the challenge determination module may select a challenge requesting that the user provide information from an RFID tag if the client 105 includes RFID scanning capabilities and the book includes an RFID tag.

In addition, the challenge determination module 405 may select multiple challenges for a book. The selected challenges may include a request that the user provide an image of the cover of a book, and also provide text found at a certain location in the book. Other combinations of challenges are also possible.

The challenge authentication module 415 receives responses to the challenges from the clients 105 and determines whether the information in the responses is correct. For example, the challenge authentication module 415 may determine whether text received in response to a challenge asking for the words at a particular location in a book matches the correct words at that location. Likewise, the challenge authentication module 415 may determine whether a hash of an image received in response to a challenge requesting a particular image matches a stored hash of the correct image.

If the information in a response is correct, an embodiment of the challenge authentication module 415 authenticates the response as correct. Typically, the correct response indicates that the user of the client 105 has possession of the physical book and therefore is entitled to receive the corresponding eBook. However, some embodiments may use additional criteria to assess whether the response authenticates. For example, the challenge authentication module 415 may maintain a list of geographic locations from which challenge responses are not allowed to authenticate, and determine whether the reported location of the client 105 is in one of these geographic locations. This location-based technique can be used to block authentications from geographic locations such as book stores and libraries where the user might gain access to a physical book without purchasing it.

Depending upon the embodiment, the challenge determination 405 and challenge authentication modules 415 can store the challenges and associated correct responses in a variety of different places. In one embodiment, the modules 405, 415 store the challenges and responses locally, within the authentication module 145. In another embodiment the challenges and responses are stored within the document repository 155 as metadata associated with the books. In yet another embodiment the challenges and responses are stored by other entities on the network 125. Further, some embodiments store the challenges and response in a variety of different locations. Hence, data for authenticating RFID-based challenges may be stored by a dedicated server on the network 125 while data for authenticating other types of challenges may be stored as metadata within the document repository 155.

The repository access module 425 provides the modules within the authentication module 145 with access to the document repository 155 and/or to other entities on the network 125. Thus, the repository access module 425 allows the challenge determination 405 and challenge authentication modules 415 to access eBook content and/or metadata in order to identify a book, select a challenge for the book, and authenticate a response to a challenge. Likewise, the repository access module 425 allows the modules to access data stored elsewhere on the network 125.

An eBook access grant module 435 grants eBook access to a client that correctly responds to the one or more challenges for a book. The eBook access grant module 435 interacts with the document repository 155 via the repository access module 145 to allow the client 105 to download or otherwise access the eBook content. Depending upon the embodiment, the eBook access grant module 435 may grant access to only a portion of the content, such as particular pages or chapters of the book.

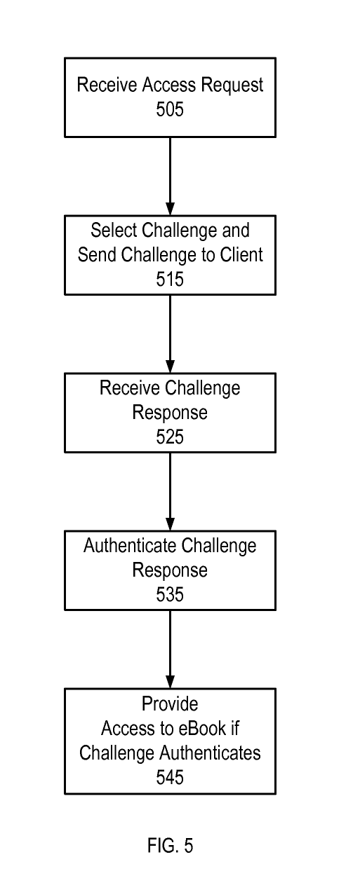

FIG. 5 is a flowchart illustrating a method for providing eBook access to a client 105 according to one embodiment. The steps of FIG. 5 may be performed by the authentication module 145. Other embodiments perform the steps of the method in different orders and include different and/or additional steps. In addition, some or all of the steps can be performed by entities other than the authentication module 145.

The authentication module 145 receives 505 an access request for an identified book in the document repository 155 from a client 105. The authentication module 145 selects 515 a challenge for the book and sends the challenge to the client 105. The authentication module 145 may select the challenge by, e.g., dynamically generating a challenge for the book or selecting a challenge from a set of pre-generated challenges. In addition, the authentication module 145 may select the challenge based on factors such as the hardware capabilities of the client 105.

The authentication module 145 receives a response to the challenge 525 from the client 105 and authenticates the response 535. A response including information correctly answering the challenge indicates that the user of the client 105 has possession of the physical book corresponding to the eBook for which access is requested. The authentication module 145 thus provides the client 105 with access to the requested eBook 545. If the information in the response is incorrect, embodiments of the authentication module 145 deny the client 105 access to the eBook and may perform steps such as offering the user of the client 105 another opportunity to respond to the same or a different challenge or offering the user access to the eBook at a different price.

The above description is included to illustrate the operation of certain embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A computer-implemented method of enabling access to electronic content comprising:
receiving a request to access identified electronic content from a client via a network;
sending a challenge for the electronic content to the client, the challenge requesting information about physical content corresponding to the identified electronic content;
authenticating a response to the challenge received from the client; and
providing the client with access to the electronic content responsive to authenticating the response.

2. The method of claim 1, wherein the electronic content comprises an electronic book (eBook) and wherein the physical content comprises a physical book corresponding to the eBook.

3. The method of claim 1, further comprising:
receiving information describing hardware capabilities of the client;
selecting the challenge for the electronic content responsive at least in part to the hardware capabilities of the client, wherein the selected challenge uses hardware capabilities described by the received information describing the hardware capabilities.

4. The method of claim 1, further comprising:
dynamically generating the challenge based on characteristics of the electronic content for which access is being requested.

5. The method of claim 1, further comprising:
selecting the challenge from among a set of pre-generated challenges associated with the electronic content.

6. The method of claim 1, wherein the challenge requests information about a specified portion of the physical content.

7. The method of claim 6, wherein the physical content is a physical book and wherein the challenge requests information about text found at a specified location within the physical book.

8. The method of claim 6, wherein the physical content is a physical book and wherein the challenge requests an image of a specified portion of the physical book.

9. The method of claim 1, wherein authenticating the response to the challenge comprises:
determining whether the response includes the requested information about the physical content corresponding to the identified electronic content, wherein the response is authenticated if the response includes the correct requested information.

10. The method of claim 1, wherein authenticating the response to the challenge comprises:
determining a geographic location of the client;
determining whether the geographic location is within a list of locations from which challenge responses are not authenticated; and
determining that the response to the challenge does not authenticate responsive to the geographic location of the client being within the list of locations.

11. A non-transitory computer-readable storage medium storing executable computer program instructions for enabling access to electronic content, the instructions performing steps comprising:
receiving a request to access identified electronic content from a client via a network;
sending a challenge for the electronic content to the client, the challenge requesting information about physical content corresponding to the identified electronic content;
authenticating a response to the challenge received from the client; and
providing the client with access to the electronic content responsive to authenticating the response.

12. The storage medium of claim 11, wherein the electronic content comprises an electronic book (eBook) and wherein the physical content comprises a physical book corresponding to the eBook.

13. The storage medium of claim 11, further comprising:
receiving information describing hardware capabilities of the client;
selecting the challenge for the electronic content responsive at least in part to the hardware capabilities of the client, wherein the selected challenge uses hardware capabilities described by the received information describing the hardware capabilities.

14. The storage medium of claim 11, wherein the challenge requests information about a specified portion of the physical content.

15. The storage medium of claim 14, wherein the physical content is a physical book and wherein the challenge requests information about text found at a specified location within the physical book.

16. The storage medium of claim 14, wherein the physical content is a physical book and wherein the challenge requests an image of a specified portion of the physical book.

17. The storage medium of claim 11, wherein authenticating the response to the challenge comprises:
determining whether the response includes the requested information about the physical content corresponding to the identified electronic content, wherein the response is authenticated if the response includes the correct requested information.

18. The storage medium of claim 11, wherein authenticating the response to the challenge comprises:
determining a geographic location of the client;
determining whether the geographic location is within a list of locations from which challenge responses are not authenticated; and
determining that the response to the challenge does not authenticate responsive to the geographic location of the client being within the list of locations.

19. A computer system for enabling access to electronic content, the computer system comprising:
a non-transitory computer-readable storage medium storing executable computer program instructions for performing steps comprising:
receiving a request to access identified electronic content from a client via a network;
sending a challenge for the electronic content to the client, the challenge requesting information about physical content corresponding to the identified electronic content;
authenticating a response to the challenge received from the client; and
providing the client with access to the electronic content responsive to authenticating the response; and
a processor for executing the computer program instructions.

20. The computer system of claim 19, wherein the electronic content comprises an electronic book (eBook) and wherein the physical content comprises a physical book corresponding to the eBook.

21. The computer system of claim 19, further comprising:
receiving information describing hardware capabilities of the client;
selecting the challenge for the electronic content responsive at least in part to the hardware capabilities of the client, wherein the selected challenge uses hardware capabilities described by the received information describing the hardware capabilities.

22. The computer system of claim 19, wherein the challenge requests information about a specified portion of the physical content.

23. The computer system of claim 22, wherein the physical content is a physical book and wherein the challenge requests information about text found at a specified location within the physical book.

24. The computer system of claim 22, wherein the physical content is a physical book and wherein the challenge requests an image of a specified portion of the physical book.

25. The computer system of claim 19, wherein authenticating the response to the challenge comprises:
determining whether the response includes the requested information about the physical content corresponding to the identified electronic content, wherein the response is authenticated if the response includes the correct requested information.

26. The computer system of claim 19, wherein authenticating the response to the challenge comprises:
determining a geographic location of the client;
determining whether the geographic location is within a list of locations from which challenge responses are not authenticated; and
determining that the response to the challenge does not authenticate responsive to the geographic location of the client being within the list of locations.
